(19) United States
(12) Patent Application Publication
(10) Pub. No.: US 2026/0049207 A1
(43) Pub. Date: Feb. 19, 2026

(54) PNEUMATIC TIRE AND RUBBER COMPOSITION COMPRISING SILANE COUPLED NANOTUBE MASTERBATC

(71) Applicant: The Goodyear Tires & Rubber Company, Akron, OH (US)

(72) Inventor: Robert Vincent Dennis-Pelcher, Uniontown, OH (US)

(21) Appl. No.: 18/806,262

(22) Filed: Aug. 15, 2024

(51) Int. Cl. C08L 15/00; B60C 1/00; C08J 3/22; C08K 3/04; C08K 3/36; C08K 5/548; C08K 9/06; C08K 13/06

(52) U.S. Cl. CPC C08L 15/00; B60C 1/00; C08J 3/226; C08K 13/06; C08J 2315/00; C08J 2409/00; C08K 3/04; C08K 3/36; C08K 5/548; C08K 9/06; C08K 2201/011; C08K 2201/014; C08L 2310/00

(57) ABSTRACT

A tire comprising a rubber composition comprising, based on 100 parts per weight elastomer, a silane-coupled carbon nanotube (CNT) in a polybutadiene masterbatch. The rubber composition further comprises a first elastomer mixed with the masterbatch. The first elastomer can be the same as or different from the polybutadiene in the masterbatch. The rubber composition optionally comprises a second elastomer mixed with the masterbatch. A total elastomer in the rubber composition comprises from about 25 phr to about 75 phr of polybutadiene and from about 25 to about 75 phr of at least the first or second elastomer.

### BACKGROUND OF THE INVENTION

Carbon nanotubes are shown to have better reinforcement per unit of material compared to traditional fillers like carbon black and silica. However, it is difficult to homogenously disperse them within a rubber matrix. It is also challenging to balance the performance properties of the magic triangle due to a lack of interaction between the nanotubes and the polymers incorporated in a tire. It is discovered herein that silane coupled nanotubes allow for better dispersion when used in a masterbatch because they promote the polymer-filler linkage.

Additionally, to achieve the balance of tire properties from rubber compositions containing a carbon nanotube, it is recognized that adjustments to rubber compositions are needed.

### SUMMARY OF THE INVENTION

One embodiment of the disclosure is directed to a tire comprising a rubber composition, which is based on 100 parts per weight elastomer and itself comprises a silane-coupled carbon nanotube (CNT) in a polybutadiene masterbatch. The rubber composition further comprises a first elastomer mixed with the masterbatch. The first elastomer can be the same as or different from the polybutadiene in the masterbatch. The rubber composition optionally comprises a second elastomer mixed with the masterbatch. A total elastomer in the rubber composition comprises from about 25 phr to about 75 phr of the polybutadiene and from about 25 to about 75 phr of at least the first or second elastomer.

Another embodiment of the disclosure is directed to a tire comprising a rubber composition, which is based on 100 parts per weight elastomer and itself comprises from about 1 phr to about 50 phr of a first polybutadiene in a dry masterbatch in which surface-functionalized carbon nanotubes are dispersed. The rubber composition further comprises a second polybutadiene blended with the masterbatch. The second polybutadiene can be the same or different from the first polybutadiene. The rubber composition optionally comprises at least another diene rubber. The rubber composition further comprises at least one reinforcement filler. The reinforcement filler comprises from about 1 to about 15 phr of the silane coupled nanotubes comprised in the masterbatch, but it may further comprise at least one additional filler including, but not limited to silica and carbon black.

The present disclosure is also related to a process for forming a rubber composition for use in a tire. The process comprises the steps of obtaining a masterbatch characterized by greater than 10% by weight surface functionalized carbon nanotubes (CNTs) dispersed in polybutadiene. The process comprises the further step of diluting the masterbatch to obtain a select level of carbon nanotubes in a final rubber composition. The diluting comprises the step of incorporating additional diene into a rubber mixture comprising the masterbatch. The additional diene can be the same or different from the first polybutadiene. The process further comprises the step of optionally incorporating filer into the rubber mixture. The final rubber composition comprises between 2 parts per weight (phr) and 15 phr of the CNTs based on 100 phr of elastomer.

### Definitions

As used herein, “carbon nanotubes” (hereinafter “CNTs”) can be classified by the number of walls as single-wall, double wall and multiwall. Each wall of a CNT can be further classified into chiral or non-chiral forms. Some of the carbon atoms of the CNT may be substituted by nitrogen atoms. Some of the walls may contain Stones-Wales defects which are defined as heptagon-pentagon pairs. CNTs are currently produced as agglomerated bundles or ropes of carbon nanotubes. The discrete carbon nanotubes can be single wall, double wall, multiwall carbon nanotubes, and any mixture thereof. The carbon nanotubes can also contain other elements within the walls of the tubes such as nitrogen or boron. The majority of the discrete carbon nanotubes have a length greater than about 0.2 micrometers. In some cases, the distribution of lengths of the discrete carbon nanotubes can be monomodal, bimodal or multimodal.

As used herein a “silane coupled nanotube” or “silane coupled CNT” has added surface functionalization to the carbon nanotubes. A method used to add this surface functionalization is to oxidize a carbon nanotube surface and then use silane chemistry to react to the hydroxyl groups present on the oxidized carbon nanotube surface. Silanes comprising disulfide or tetrasulfide moieties are most preferred. More specifically, unsaturated molecules, bis(3-triethoxysilylpropyl)tetrasulfide, (obtained as Si69 from Evonik), bis(3-tricthoxysilylpropyl)disulfide (obtained as Si75 from Evonik), and 3-thiocyanatopropyltriethoxysilane (obtained as Si264 from Evonik) are preferred silanes for coupling to hydroxyl and carboxylic acid groups of oxidized carbon nanotubes. Alternatively, a γ-tert-butylperoxypropyl trimethoxy silane, or an azide sulfonyl silane could be employed. Suitable surface-functionalized multiwall carbon nanotubes are available commercially from Molecular Rebar Design, LLC of Austin, Texas.

### DETAILED DESCRIPTION OF THE INVENTION

The present invention relates to a rubber composition and tire incorporating the same. The rubber composition comprises a unique masterbatch comprising sulfur-silane-functionalized carbon nanotubes and polybutadiene.

US 2024/0026126 to Molecular Rebar Design discloses that the addition of Si69 (denoted as TESPT or bis[3-(triethoxysilyl)propyl]tetrasulfide) does not meaningfully change a baseline polymer, but only tensile properties. The use of oxidized carbon nanotubes (CNTs) alone (with no silane functionalization) increases both tensile strength and modulus, demonstrating improved reinforcement. The modulus and tensile strength are further improved from the same loadings of carbon nanotubes without the silane. The '126 publication observed that the combinative effects of carbon nanotubes with coupled sulfur groups through Si69 are superior to the effects of oxidized MR by itself or Si69 by itself on the baseline polymer system.

The '126 patent reports on 10% sulfur-silane-functionalized carbon nanotubes in a masterbatch with SSBR. The '126 masterbatch is diluted with, additional SSBR and polybutadiene. The resulting blend comprises a majority portion of SSBR (when the rubber composition comprises 100 parts per weight (phr) of elastomer) made up of the SSBR from the masterbatch and freely added SSBR. The '126 publication is silent on wet and dry grip despite its SSBR-CNT masterbatch showing improve tensile (indicative of treadwear) and rolling resistance when employed over conventional polymer blends.

The current invention investigates the use of sulfur-silane-functionalized carbon nanotubes in a masterbatch formed with polybutadiene in place of SSBR. A rubber composition is desired that improves all properties in the magic triangle without demanding any trade-offs.

### Silane Coupled Nanotube

US20230192985 to Molecular Rebar Design, LLC, which is incorporated herein by reference in its entirety, describes one general method of attaching the surface functionality to carbon nanotubes. Such method is to add the plurality of discrete oxidized carbon nanotubes to a mixture of unsaturated molecules, preferably polybutadiene, mix in a mixer such as a Banbury mixer to obtain a dispersion of the plurality of discrete oxidized carbon nanotubes, but keeping the temperature of the mix less than that temperature required for the functional group to crosslink the unsaturated molecules. A master batch can be made by this method, which can then be diluted or not as desired.

### Masterbatch

The silane coupled carbon nanotubes are present in the masterbatch in an amount of at least 1 phr up to 15 phr. In one embodiment, the silane coupled carbon nanotubes are present between 5 phr and 10 phr. Carbon nanotubes according to the embodiments of the invention are generally parallel, multi-walled carbon nanotubes. In one embodiment, the carbon nanotubes have a nested structure of from 3 walls to 15 walls. Carbon nanotubes are very small diameter fibers with high aspect ratio. For example, individual fibers may have an average diameter in a range of from about 1 nm to about 40 nm and by way of further example, may have average diameters in a range from 5 nm to 30 nm and by further example, in a range from 15 nm to 30 nm. Individual fibers may have an average length of between 500 nm and 30,000 nm. In one embodiment, the carbon nanotubes may have an average length less than 1,000 nm, for example, about 900 nm. The length to diameter ratio of the carbon nanotubes is at least 20, meaning the length is at least 20 times greater than the diameter.

The carbon nanotubes may be produced from high purity, low molecular weight hydrocarbons in a continuous, gas phase, catalyzed reaction or by other means/methods. As produced, the carbon nanotubes may be intertwined together in agglomerates. These tangled agglomerates of carbon nanotubes may be untangled and/or dispersed prior to use. Though not required, one or more surfaces of the carbon nanotubes may be modified during or following their synthesis.

In one embodiment, modification includes adding oxygen or oxygenated functional groups to the surface of the carbon nanotubes. This may be achieved by acid treating the carbon nanotubes so that they may be functionalized with OH and COOH groups. To that end, modification of the carbon nanotubes may include treatment in an oxygen-containing environment. Carbon of the nanotube atomic structure may bond with oxygen via a reaction with oxygen or an oxygen-containing reactant. The oxygen or oxygen-containing reactant may bond to the surface of the as-formed carbon nanotube or may diffuse into the structure of the tube wall. The amount of oxygen in the carbon nanotubes following modification may range from 0.25 wt. % to 15 wt. %. Usable carbon nanotubes are commercially available from Molecular Rebar Design, LLC of Austin, Tex. as MRO Gen II in naphthenic oil.

One aspect of this disclosure is the incorporation of the silane coupled CNTs into a diene elastomer masterbatch. There is no limitation herein to the type of diene elastomer employed. In a preferred embodiment, the diene elastomer is a cis-1,4-polybutadiene rubber (BR or PBD). Suitable polybutadiene rubbers may be prepared, for example, by organic solution polymerization of 1,3-butadiene. The BR may be conveniently characterized, for example, by having at least a 90 wt. % cis-1,4-microstructure content (“high cis” content), or at least 95 wt. %, or at least 96 wt. %. A glass transition temperature (Tg) of the BR may range of from −90 to −115° C. The BR may have a Mooney viscosity of 45-65. Suitable polybutadiene rubbers are available commercially, such as Budene® 1207, Budene® 1208, Budene® 1223, and Budene® 1280 from The Goodyear Tire & Rubber Company. These high cis-1,4-polybutadiene rubbers can for instance be synthesized utilizing nickel catalyst systems which include a mixture of (1) an organonickel compound, (2) an organoaluminum compound, and (3) a fluorine containing compound as described in U.S. Pat. Nos. 5,698,643 and 5,451,646. For example, cis-1,4-polybutadiene rubber obtained as Budene® 1207 from The Goodyear Tire & Rubber Company has a 1,4-content of at least 96 wt. % and a Tg of −100° C.

The diene elastomer comprised in the masterbatch may be non-functional or functional.

The masterbatch may be used in the rubber composition an amount between 1 and 50 phr. In the rubber composition, the amount of diene elastomer from the masterbatch may be between 1 and less than 50 phr and, more preferably between 10 and 40 phr and, most preferably, between 15 and 35 phr.

### Elastomers

One or more sulfur vulcanizable elastomers may be mixed with the masterbatch to form the final rubber composition. At least one elastomer preferably includes at least one double bond, e.g., a C═C bond, such as diene-based elastomers.

In one embodiment, the elastomers are a product of the polymerization of 1,3-butadiene, such as a butadiene rubber (BR) and/or a styrene-butadiene rubber (SBR).

In one embodiment, the only elastomers used in the rubber composition are product(s) of the polymerization of 1,3-butadiene. In one embodiment, at least one elastomer used in the rubber composition is a product(s) of the polymerization of 1,3-butadiene.

By convention, the total amount of elastomer in the rubber composition is 100 phr.

### a) The Butadiene Rubber

The butadiene rubber may be a synthetic polybutadiene which is the homo-polymerization product of a single monomer: butadiene.

In one embodiment, a cis-1,4-polybutadiene rubber (BR or PBD) is used. Suitable polybutadiene rubbers may be prepared, for example, by organic solution polymerization of 1,3-butadiene. The BR may be conveniently characterized, for example, by having at least a 90 wt. % cis-1,4-microstructure content (“high cis” content), or at least 95 wt. %, or at least 96 wt. %. A glass transition temperature (Tg) of the BR may range of from −95 to −112° C. The BR may have a Mooney viscosity of 45-65. Suitable polybutadiene rubbers are available commercially, such as Budene® 1207, Budene® 1208, Budene® 1223, and Budene® 1280 from The Goodyear Tire & Rubber Company. These high cis-1,4-polybutadiene rubbers can for instance be synthesized utilizing nickel catalyst systems which include a mixture of (1) an organonickel compound, (2) an organoaluminum compound, and (3) a fluorine containing compound as described in U.S. Pat. Nos. 5,698,643 and 5,451,646. For example, cis-1,4-polybutadiene rubber obtained as Budene® 1207 from The Goodyear Tire & Rubber Company has a 1,4-content of at least 96 wt. % and a Tg of −100° C.

The BR (hereinafter also referred to as “freely added” polybutadiene as distinguished from a polybutadiene in the masterbatch” may be used in the rubber composition in an amount between 1 and 50 phr and, more preferably between 5 and 25 phr and, most preferably, between 15 and 35 phr. For embodiments in which the additional elastomer comprises polybutadiene, the polybutadiene in the masterbatch can be present at more or less than a freely added polybutadiene. Additionally, in such embodiments, the polybutadiene comprised in the masterbatch can be the same as or different from the polybutadiene mixed with the masterbatch.

### b) Styrene-Butadiene Rubber (SBR)

The SBR may be an emulsion-polymerized styrene-butadiene rubber (ESBR) and/or a solution-polymerized styrene-butadiene rubber (SSBR).

In one embodiment, the SBR is an SSBR. In one embodiment, the SSBR has a medium styrene microstructure and can be further characterized by a bound styrene content between 20 and 40%.

In one embodiment, the SBR is functionalized. Example SBRs are functionalized with at least one aminosilane group, such as the polymers disclosed in co-owned US Publication 2022/0177610, which is incorporated by reference herein.

Example SSBRs are sold under the tradename SLF by The Goodyear Tire & Rubber Company. Another example SSBR that can be used includes Sprintan SLR4602 from Synthos. Similarly performing functionalized SSBRs with other functional groups are also contemplated.

If used, the SBR may be used in the rubber composition in an amount of between 25 phr to 75 phr and, in one embodiment, between 50 phr and 75 phr or, in another embodiment, less than 50.

### c) Other Elastomers

Other vulcanizable elastomers may be present in minor amounts (e.g., totaling up to 10 wt. %, or up to 5 wt. %, or up to 2 wt. % of the elastomers), and may be selected from natural rubber, synthetic polyisoprene, halobutyl rubber, e.g., bromobutyl rubber and chlorobutyl rubber, nitrile rubber, liquid rubbers, polynorbornene copolymer, isoprene-isobutylene copolymer, ethylene-propylene-diene rubber, chloroprene rubber, acrylate rubber, fluorine rubber, silicone rubber, polysulfide rubber, epichlorohydrin rubber, styrene-isoprene-butadiene terpolymer, hydrated acrylonitrile butadiene rubber, isoprene-butadiene copolymer, butyl rubber, hydrogenated styrene-butadiene rubber, butadiene acrylonitrile rubber, a terpolymer formed from ethylene monomers, propylene monomers, and/or ethylene propylene diene monomer (EPDM), isoprene-based block copolymers, butadiene-based block copolymers, styrenic block copolymers, styrene-butadiene-styrene block copolymer (SBS), styrene-ethylene/butylene-styrene block copolymer (SEBS), styrene-[ethylene-(ethylene/propylene)]-styrene block copolymer (SEEPS), styrene-isoprene-styrene block copolymer (SIS), random styrenic copolymers, hydrogenated styrenic block copolymers, styrene butadiene copolymers, polyisobutylene, ethylene vinyl acetate (EVA) polymers, polyolefins, amorphous polyolefins, semi-crystalline polyolefins, alpha-polyolefins, reactor-ready polyolefins, acrylates, metallocene-catalyzed polyolefin polymers and elastomers, reactor-made thermoplastic polyolefin elastomers, olefin block copolymer, copolyester block copolymer, polyurethane block copolymer, polyamide block copolymer, thermoplastic polyolefins, thermoplastic vulcanizates, ethylene vinyl acetate copolymer, ethylene n-butyl acrylate copolymer, ethylene methyl acrylate copolymer, neoprene, acrylics, urethane, poly(acrylate), ethylene acrylic acid copolymer, polyether ether ketone, polyamide, atactic polypropylene, polyethylene including atactic polypropylene, ethylene-propylene polymers, propylene-hexene polymers, ethylene-butene polymers, ethylene octene polymers, propylene-butene polymers, propylene-octene polymers, metallocene-catalyzed polypropylene polymers, metallocene-catalyzed polyethylene polymers, ethylene-propylene-butylene terpolymers, copolymers produced from propylene, ethylene, C₄-C₁₀ alpha-olefin monomers, polypropylene polymers, maleated polyolefins, polyester copolymers, copolyester polymers, ethylene acrylic acid copolymer, and/or polyvinyl acetate, and/or wherein the polymer optionally comprises a modification and/or functionalization selected from one or more of hydroxyl-, ethoxy-, epoxy-, siloxane-, amine-, aminesiloxane-, carboxy-, phthalocyanine-, and silane-sulfide-groups, at the polymer chain ends or pendant positions within the polymer.

### Fillers

The rubber composition may include from about 1 to about 200 phr of silica. The term “silica” is used herein to refer to silicon dioxide, SiO₂ (which may contain minor amounts of impurities, generally less than 1 wt. %, resulting from the process in which the silica is formed). The silica may be a precipitated silica which formed by digesting amorphous silica with sodium hydroxide to form sodium silicate and precipitating silica from sodium silicate by reaction with an acidifying agent, such as sulfuric acid or carbon dioxide. The resulting precipitate is washed and filtered.

The exemplary silica is referred to as a low surface area silica. By this, it is meant that the silica may have a CTAB specific surface area of up to 180 m²/g, or up to 160 m²/g, or up to 140 m²/g. CTAB surface area is measured according to ASTM D6845-20 “Standard Test Method for Silica, Precipitated, Hydrated—CTAB (Cetyltrimethylammonium Bromide) Surface Area.” This test method covers the measurement of the specific surface area of precipitated silica, exclusive of area contained in micropores too small to admit hexadecyltrimethylammonium bromide (cetyltrimethylammonium bromide, commonly referred to as CTAB) molecules.

The low surface area silica may have a BET specific surface of at least 110 m²/g, or up to 200 m²/g. The BET specific surface is determined according to the Brunauer-Emmett-Teller method according to the standard ISO 5794-1:2022, Appendix D.

Exemplary precipitated low surface area silicas are available from Evonik e.g., as Zeosil 1116, which has a CTAB specific surface area of 140 m²/g; from Ultrasil™ VN2GR, which has a CTAB specific surface area of 130 m²/g; and from PPG, e.g., as Hi-Sil 210 or Hi-Sil 243 or Hi-Sil315, which have a CTAB specific surface areas of 130 m²/g.

In some embodiments, the low surface area silica may be combined with another silica material.

In some embodiments, a coupling agent, such as a silane coupling agent, may be provided to covalently bond the silica to the elastomer. Common coupling agents are sulfur-containing organosilicon compounds, such as polysulfane (alkyltrialkoxysilanes) and mercapto functionalized organosilanes. One example silica coupler, available under the tradename Si266 from Evonik, is comprised of bis(triethoxysilylpropyl)disulfide (TESPD) containing an average in a range of from about 2 to about 2.6 connecting sulfur atoms in its polysulfidic bridge. Another suitable mercapto silane is bis(3-triethoxysilyl-propyl)tetrasulfide (TESPT), available under the tradename Si69 from Evonik.

In one embodiment, the silane coupling agent can be comprised in the masterbatch. In one embodiment, the silane coupling agent can be freely added to a mixture comprising the masterbatch. In one embodiment, silane coupling agent can be comprised in the masterbatch and freely added to the mixture comprising the masterbatch. In such embodiment, the silane coupling agent comprised in the masterbatch can be the same as or different from the silane coupling agent mixed with the masterbatch. In one embodiment, the freely added silane can be a blocked mercaptosilane, such as TESPD.

A suitable amount of silica coupler in the rubber composition is between 0.1 and 10.0 phr.

Some embodiments may optionally comprise carbon black in addition to silica. Exemplary carbon blacks useful herein include ASTM designations N110, N121, N134, N220, N231, N234, N242, N293, N299, N315, N326, N330, N332, N339, N343, N347, N351, N358, N375, N539, N550, N582, N630, N642, N650, N683, N754, N762, N765, N774, N787, N907, N908, N990 and N991, as specified by ASTM D1765-21, “Standard Classification System for Carbon Blacks Used in Rubber Products.” These carbon blacks have iodine absorptions ranging from 9 to 145 g/kg and DBP number ranging from 34 to 150 cm³/100 g.

Reinforcing fillers, other than the silica and carbon black, may be utilized, e.g., in amounts of up to 30 phr, or up to 20 phr, or up to 10 phr, or up to 1 phr, or may be absent. Examples of such additional reinforcing fillers include alumina, aluminum hydroxide, clay (reinforcing grades), magnesium hydroxide, boron nitride, aluminum nitride, titanium dioxide, reinforcing zinc oxide, and combinations thereof.

In some embodiments, one or more non-reinforcing fillers may be used in the rubber composition. Examples of such fillers include clay (non-reinforcing grades), graphite, magnesium dioxide, starch, boron nitride (non-reinforcing grades), silicon nitride, aluminum nitride (non-reinforcing grades), calcium silicate, silicon carbide, ground rubber, and combinations thereof. The term “non-reinforcing filler” is used to refer to a particulate material that has a nitrogen absorption specific surface area (N2SA) of 20 m²/g, or less, e.g., 10 m²/g or less. The N2SA surface area of a particulate material is determined according to ASTM D6556-21, “Standard Test Method for Carbon Black-Total and External Surface Area by Nitrogen Adsorption.” In certain embodiments, non-reinforcing fillers may be a particulate material that has a particle size of greater than 1000 nm.

A total amount of non-reinforcing filler may be 0 to 10 phr, or up to 5 phr, or up to 1 phr.

### Processing Aids

Processing aids may be used at a total of 30 to 100 phr and may include one or more of a resin, a wax, and a liquid plasticizer.

### a) Resins

Optionally, the rubber composition may comprise a resin. Example resins that may be used in the rubber composition include a plasticizing hydrocarbon resin. A plasticizing hydrocarbon resin is a hydrocarbon compound that is solid at ambient temperature (e.g., 23° C.) as opposed to a liquid plasticizing compound, such as a plasticizing oil, and which may be used between 1 and 30 phr. Example hydrocarbon resins include aromatic, aliphatic, and cycloaliphatic resins.

In one embodiment, the hydrocarbon resin is present in the rubber composition in a total amount of at least 30 phr, or at least 35 phr, or up to 75 phr, or up to 65 phr, or up to 55 phr.

The hydrocarbon resin may have a Tg (measured by Differential Scanning calorimetry (DSC) in accordance with ASTM D3418 (1999)) of at least 30° C., or up to 70° C. Hydrocarbon resin Tg can be determined by DSC, according to the procedure discussed above for elastomer Tg measurements.

The hydrocarbon resin may have a softening point of at least 70° C., or up to 100° C. The softening point of a hydrocarbon resin is generally related to the Tg. The Tg is generally lower than its softening point, and the lower the Tg the lower the softening point.

Examples of aliphatic resins include C5 fraction homopolymer and copolymer resins. Examples of cycloaliphatic resins include cyclopentadiene (“CPD”) homopolymer or copolymer resins, dicyclopentadiene (“DCPD”) homopolymer or copolymer resins, and combinations thereof.

Examples of aromatic resins include aromatic homopolymer resins and aromatic copolymer resins. An aromatic copolymer resin refers to a hydrocarbon resin which comprises a combination of one or more aromatic monomers in combination with one or more other (non-aromatic) monomers, with the majority by weight of all monomers generally being aromatic.

Specific examples of aromatic resins include coumarone-indene resins, alkylphenol resins, and vinyl aromatic homopolymer or copolymer resins. Examples of alkylphenol resins include alkylphenol-acetylene resins such as p-tert-butylphenol-acetylene resins, alkylphenol-formaldehyde resins (such as those having a low degree of polymerization). Vinyl aromatic resins may include one or more of the following monomers: alpha-methylstyrene, styrene, ortho-methylstyrene, meta-methylstyrene, para-methylstyrene, vinyltoluene, para (tert-butyl) styrene, methoxystyrene, chlorostyrene, hydroxystyrene, vinylmesitylene, divinylbenzene, vinylnaphthalene and the like. Examples of vinylaromatic copolymer resins include vinylaromatic/terpene copolymer resins (e.g., limonene/styrene copolymer resins), vinylaromatic/C5 fraction resins (e.g., C5 fraction/styrene copolymer resin), vinylaromatic/aliphatic copolymer resins (e.g., CPD/styrene copolymer resin, and DCPD/styrene copolymer resin).

Other aromatic resins include terpene resins, such as alpha-pinene resins, beta-pinene resins, limonene resins (e.g., L-limonene, D-limonene, dipentene which is a racemic mixture of L- and D-isomers), beta-phellandrene, delta-3-carene, delta-2-carene, and combinations thereof.

In one embodiment, the hydrocarbon resin includes a combination of aromatic and aliphatic/cycloaliphatic hydrocarbons, meaning that the polymeric base of the resin may be formed from aliphatic and/or aromatic monomers.

The plasticizing hydrocarbon resins useful in one embodiment of the present invention include those that are homopolymers or copolymers of cyclopentadiene (CPD) or dicyclopentadiene (DCPD), homopolymers or copolymers of terpene, homopolymers or copolymers of C₅ cut, the C₉ cut (or, more generally, from a C₈ to C₁₀ cut)), and mixtures thereof.

The hydrocarbon resin may have a Mw of at least 1000 g/mol and/or up to 4000 grams/mole.

The resin can be hydrogenated in some embodiments. The resin can be modified in some embodiments.

Commercially available plasticizing resins that include C₅ cut/C₉ cut copolymer resins suitable for use in the present invention include OPPERA PR373 from ExxonMobil.

A total amount of resin in the rubber composition may be 50 phr or less and, more preferably, 30 phr or less and most preferably, 20 phr or less.

### b) Liquid Plasticizers (Including Oils and Non-Oils)

The term liquid plasticizer is used to refer to plasticizer ingredients which are liquid at room temperature (i.e., liquid at 25° C. and above). Hydrocarbon resins, in contrast to liquid plasticizers, are generally solid at room temperature. Generally, liquid plasticizers will have a Tg that is below 0° C., generally well below, such as less than −30° C., or less than −40° C., or less than −50° C., such as a Tg of 0° C. to −100° C.

Suitable liquid plasticizers include oils (e.g., petroleum oils as well as plant-sourced oils) and non-oil liquid plasticizers, such as ether plasticizers, ester plasticizers, phosphate plasticizers, and sulfonate plasticizers. Liquid plasticizer may be added during the compounding process or later, as an extender oil (which is used to extend a rubber). Petroleum based oils may include aromatic, naphthenic, low polycyclic aromatic (PCA) oils, and mixtures thereof. Plant oils may include oils harvested from vegetables, nuts, seeds, and mixtures thereof, such as triglycerides.

A total amount of liquid plasticizer in the rubber composition may be 50 phr or less and, more preferably, 40 phr or less and most preferably, 30 phr or less.

A total amount of plasticizer (liquid and resin) in the rubber composition may be 80 phr or less and, more preferably, 60 phr or less and most preferably, 40 phr or less.

### c) Waxes

Wax is optionally employed in the disclosed rubber composition. Suitable waxes include paraffin waxes and microcrystalline waxes, which may be of the type described in The Vanderbilt Rubber Handbook (1978), pp. 346 and 347. Such waxes can serve as antiozonants.

The wax(es) may be present at 0.1 phr or more, such as at least 0.3 phr, or at least 0.5 phr, or up to 5 phr, or up to 4 phr, or up to 2 phr.

In addition to one or more of the above processing aids, the rubber composition may include a peptizer, such as pentachlorothiophenol, dibenzamidodiphenyl disulfide, or a mixture thereof. Typical amounts of peptizer, if used, may be 0.1 phr to 1 phr.

### Antioxidants and Antidegradants

Exemplary antioxidants suited to use in the rubber composition include amine based antioxidants, such as paraphenylenediamines (PPDs), e.g., N-(1,3-dimethylbutyl)-N′-phenyl-p-phenylenediamine (6PPD), para-phenylenediamine, and others, such as those disclosed in The Vanderbilt Rubber Handbook (1978), pages 344-346. Such antioxidants may also serve as antiozonants and may be used at from 0.1 to 5 phr, such as at least 0.3 phr, or at least 1 phr, or at least 2 phr. In some embodiments, at least a portion of the antioxidant is provided in SBR, if optionally employed.

Antidegradants, where used, may include amine based antidegradants and phenol-containing antidegradants, and may be used at from 1 to 5 phr. Phenol-containing antidegradants include polymeric hindered phenol antioxidants, and others, such as those included in The Vanderbilt Rubber Handbook (1978), pages 344-347.

### Cure Package

The cure package includes a) a vulcanizing (cure) agent, b) optionally at least one of: a cure accelerator, a cure activator, and a cure inhibitor. The cure package may be used in the rubber composition at 0.5 to 20 phr, or at least 5 phr, or up to 10 phr.

### a) Vulcanizing (Cure) Agent

The vulcanization of the rubber composition is conducted in the presence of a vulcanizing agent, such as a sulfur vulcanizing agent.

Examples of suitable sulfur vulcanizing agents include elemental sulfur (free sulfur), insoluble polymeric sulfur, soluble sulfur, and sulfur donating vulcanizing agents, for example, an amine disulfide, polymeric polysulfide, or sulfur olefin adduct, and mixtures thereof.

Sulfur vulcanizing agents may be used in an amount of from 0.1 to 10 phr, such as at least 0.4 phr, or up 5 phr, or up to 2 phr.

### b) Cure Accelerators, Cure Activators, and Inhibitors

Cure accelerators and activators act as catalysts for the vulcanization agent. Accelerators are used to control the time and/or temperature required for vulcanization and to improve the properties of the vulcanizate. In one embodiment, a single accelerator system may be used, i.e., primary accelerator. A primary accelerator may be used in amounts ranging from 0.5 to 5 phr. In another embodiment, combinations of two or more accelerators may be used. In this embodiment, a primary accelerator is generally used in the larger amount (0.1 to 3 phr), and a secondary accelerator is generally used in smaller amounts (0.05 to 3 phr), in order to activate and to improve the properties of the vulcanizate. Combinations of such accelerators have historically been known to produce a synergistic effect of the final properties of sulfur-cured rubbers and are often somewhat better than those produced by use of either accelerator alone. In addition, delayed action accelerators may be used which are less affected by normal processing temperatures but produce satisfactory cures at ordinary vulcanization temperatures.

Representative examples of accelerators include amines, disulfides, guanidines, thioureas, thiazoles, thiurams, sulfenamides, dithiocarbamates and xanthates. In one embodiment, the primary accelerator is a sulfenamide. If a second accelerator is used, the secondary accelerator may be a guanidine, dithiocarbamate or thiuram compound, although a second sulfonamide accelerator may be used.

Examples of thiazole cure accelerators include 2-mercaptobenzothiazole, 2,2′-dithiobis(benzothiazole) (MBTS). Guanidine cure accelerators include diphenyl guanidine (DPG). Examples of sulfenamide cure accelerators include benzothiazole sulfenamides, such as N-cyclohexyl-2-benzothiazolesulfenamide (CBS), and N-tert-butyl-2-benzothiazole-sulfonamide (TBBS).

Cure accelerators having a vulcanization initiation time, referred to as “t0,” of less than 3 minutes are referred to as ultra-accelerators. Example ultra-accelerators include 1,6-bis(N,N′-dibenzylthiocarbamoyldithio) hexane (BDBZTH), tetrabenzylthiuram disulfide (TBzTD), tetramethyl thiuram monosulfide (TMTM), tetramethyl thiuram disulfide (TMTD), tetraethyl thiuram disulfide (TETD), tetraisobutyl thiuram disulfide (TiBTD), dipentamethylene thiuram tetrasulfide (DPTT), zinc dibutyl dithiocarbamate (ZDBC), zinc diethyl dithiocarbamate, zinc dimethyl dithiocarbamate, copper dimethyl dithiocarbamate, tellurium diethyl dithiocarbamate (TDEC), zinc dibenzyl dithiocarbamate (ZBED), zinc diisononyl dithiocarbamate, zinc pentamethylene dithiocarbamate, zinc dibenzyldithiocarbamate (ZBEC), zinc isopropyl xanthate (ZIX), zinc butyl xanthate (ZBX), sodium ethyl xanthate (SEX), sodium isobutyl xanthate (SIBX), sodium isopropyl xanthate (SIPX), sodium n-butyl xanthate (SNBX), sodium amyl xanthate (SAX), potassium ethyl xanthate (PEX), potassium amyl xanthate (PAX), zinc 2-ethylhexylphosphorodithioate (ZDT/S), and mixtures thereof.

The amount of the cure accelerator may be from 0.1 to 10 phr, or at least 0.5 phr, or at least 2 phr, or up to 8 phr, or up to 5 phr.

Cure activators are additives which are used to support vulcanization. Cure activators include both inorganic and organic cure activators. Zinc oxide is the most widely used inorganic cure activator and may be present at 1 phr to 10 phr, e.g., at least 1 phr, or up to 5 phr.

Organic cure activators include stearic acid, palmitic acid, lauric acid, zinc salts of each of the foregoing, and thiourea compounds, e.g., thiourea, and dihydrocarbylthioureas such as dialkylthioureas and diarylthioureas, and mixtures thereof. Specific thiourea compounds include N,N′-diphenylthiourea, trimethylthiourea, N,N′-diethylthiourea (DEU), N,N′-dimethylthiourca, N,N′-dibutylthiourea, ethylenethiourea, N,N′-diisopropylthiourea, N,N′-dicyclohexylthiourca, 1,3-di(o-tolyl)thiourea, 1,3-di(p-tolyl)thiourea, 1,1-diphenyl-2-thiourea, 2,5-dithiobiurea, guanylthiourea, 1-(1-naphthyl)-2-thiourea, 1-phenyl-2-thiourea, p-tolylthiourea, and o-tolylthiourea.

The total amount of organic cure activator(s) may be from 0.1 to 6 phr, such as at least 0.5 phr, or at least 1 phr, or up to 4 phr.

Cure inhibitors are used to control the vulcanization process and generally retard or inhibit vulcanization until the desired time and/or temperature is reached. Example cure inhibitors include cyclohexylthiophthalimide.

The amount of cure inhibitor, if used, may be 0.1 to 3 phr, or 0.5 to 2 phr.

The disclosed rubber composition can be incorporated into a tire component. Representative of such tire component is, for example, a tire tread such including at least one of tread cap and/or tread base rubber layer tire sidewall, tire carcass component, such as, for example, a carcass cord ply coat, tire sidewall stiffening insert, an apex adjacent to or spaced apart from a tire bead, wire coat, inner liner tire chafer and/or tire bead component. The tread and/or tires can be built, shaped, molded and cured by various methods which will be readily apparent to those skilled in the art. In practice, the tire tread is intended to be ground-contacting. The tires can be pneumatic or non-pneumatic.

### Preparing the Rubber Composition:

A pneumatic tire of the present invention may be a race tire, passenger tire, aircraft tire, agricultural, earthmover, off-the-road, truck tire, and the like. In one embodiment, the tire is a passenger or truck tire. The tire may also be a radial or bias.

The mixing of the rubber composition can be accomplished by methods known to those having skill in the rubber mixing art. For example, the ingredients are typically mixed in at least two stages, namely, at least one non-productive stage followed by a productive mix stage. The final curatives including sulfur-vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period suitable in order to produce a rubber temperature between 140° C. and 190° C. The appropriate duration of the thermomechanical working varies as a function of the operating conditions, and the volume and nature of the components. For example, the thermomechanical working may be from 1 to 20 minutes.

After mixing, in one embodiment, the compounded rubber can be fabricated such as, for example, by extrusion through a suitable die to form a tire tread (including tread cap and tread base). The tire tread is typically built onto a sulfur curable tire carcass and the assembly thereof cured in a suitable mold under conditions of elevated temperature and pressure by methods well-known to those having skill in the art.

If used herein, the terms “compounded rubber”, “rubber compound” and “compound” refer to rubber compositions containing elastomers which have been compounded, or blended, with appropriate rubber compounding ingredients. The terms “rubber” and “elastomer” may be used interchangeably unless otherwise indicated. It is believed that such terms are well known to those having skill in the art.

The following examples are presented for the purposes of illustrating and not limiting the present invention. All parts are parts by weight (phr) unless specifically identified otherwise.

### Example I

In these examples, the effects of the disclosed combinations on the performance of a rubber compound are illustrated. Rubber compositions were mixed in a multi-step mixing procedure following the recipes in Table 1.

Cure properties were determined using a Monsanto oscillating disc rheometer (MDR) which was operated at a temperature of 150° C. and at a frequency of 11 hertz. A description of oscillating disc rheometers can be found in The Vanderbilt Rubber Handbook edited by Robert O. Ohm (Norwalk, Conn., R. T. Vanderbilt Company, Inc., 1990), Pages 554 through 557. The use of this cure meter and standardized values read from the curve are specified in ASTM D-2084. A typical cure curve obtained on an oscillating disc rheometer is shown on Page 555 of the 1990 edition of The Vanderbilt Rubber Handbook.

Viscoelastic properties (G′ and tan delta TD) were measured using an ARES Rotational Rheometer rubber analysis instrument which is an instrument for determining various viscoelastic properties of rubber samples, including their storage moduli (G′) over a range of in torsion as measured at 3% strain and a frequency of 10 Hz. Generally, a higher G′ at 30° C. indicates a better handling performance for a tire containing the given compound. Tan delta is given as measured at 10% strain and a frequency of 10 Hz at 0° C. Generally, a higher tan delta at 0° C. indicates improved wet traction in a tire containing the given compound.

Other viscoelastic properties were determined using a Flexsys Rubber Process Analyzer (RPA) 2000. A description of the RPA 2000, its capability, sample preparation, tests and subtests can be found in these references. H A Pawlowski and J S Dick, Rubber World, June 1992; J S Dick and H A Pawlowski, Rubber World, January 1997; and J S Dick and J A Pawlowski, Rubber & Plastics News, April 26 and May 10, 1993.

Rebound is a measure of hysteresis of the compound when subject to loading, as measured by ASTM D1054. Generally, the higher the measured rebound at 60° C. and 100° C., the lower the rolling resistance in a tire containing the given compound.

Abrasion was determined as Grosch abrasion rate as run on a LAT-100 Abrader and measured in terms of mg/km of rubber abraded away. The test rubber sample is placed at a slip angle under constant load (Newtons) as it traverses a given distance on a rotating abrasive disk (disk from HB Schleifmittel GmbH). A high abrasion severity test may be run, for example, at a load of 70 newtons, 12° slip angle, disk speed of 20 km/hr for a distance of 250 meters. Additional abrasion measurements were determined using relative volume loss tested using DIN abrasion relative to a standard according to ASTM D5693 at a load of 10 N.

Shore A hardness was measured according to ASTM D2240. “Elongation at break” refers to the percentage of the original length of a rubber or elastomeric material to which the material is extended at rupture, when the material is subjected to a stretching or tensile force.

The control is a conventional tread compound containing an SSBR/polybutadiene blend typical of many tread compounds. The inventive sample contains equal or approaching equal parts waxes, fatty acids, antiozonants, plasticizers, zinc oxide, sulfur with a slight adjustment to the level of accelerator for curing.

Various cured rubber properties of the Control A and Experimental Samples B are reported in the following Table 2 with the results for tires of treads formed from Control rubber composition A being normalized to values of 100 and results for experimental tires with treads of rubber composition B being compared to the normalized values of 100 for Control A tire.

TABLE 1

| | | Inventive |
|---|---|---|
| | Control | Sample |
| silane coupled carbon nanotube MB (20% | 0 | 38 |
| nanotubes)^{A} | | |
| High cis Polybutadiene^{B} | 38 | 9 |
| SSBR^{C} | 62 | 62 |
| Carbon black | 4 | 5 |
| Precipitated silica w/BET 160 m2/gm | 95 | 65 |
| Mercapto silane | 7.5 | 0 |
| Blocked mercapto silane | 0 | 5.5 |
| Processing aid | 0 | 2.5 |

^{A}30 phr PBD; 7 phr nanotubes; 1 phr silane
^{B}obtained from The Goodyear Tire & Rubber Company as BUD1223
^{C}functionalized w/medium styrene (21)/high vinyl microstructure (50)

TABLE 2

| | | | Inventive |
|---|---|---|---|
| | | Control | Sample |
| | Curing Conditions | 10 min @ 170° C. | |
| | Specific Gravity (g/cm³) | 100% | 98% |
| Cure | Delta Torque MDR 150° C. | 100% | 100% |
| Stiffness | RPA G′ 1% (MPa) | 100% | 98% |
| higher is better | RPA G′ 10% (MPa) | 100% | 99% |
| | RPA G′ 50% (MPa) | 100% | 105% |
| | ARES G′ 1%, 30° C. (MPa) | 100% | 152% |
| | ARES G′ 10%, 30° C. (MPa) | 100% | 141% |
| | ARES G′ 1%, 60° C. (MPa) | 100% | 119% |
| | ARES G′ 10%, 60° C. (MPa) | 100% | 111% |
| Wet Indicator | ARES Tan Delta, 0° C. higher is | 100% | 126% |
| | better | | |
| | Rebound 0% lower is better | 100% | 84% |
| Hysteresis/RR | Rebound 23% higher is better | 100% | 86% |
| | Rebound 60% higher is better | 100% | 100% |
| | Rebound 100% higher is better | 100% | 105% |
| | RPA TD 10% lower is better | 100% | 91% |
| Hardness | Shore A (0° C.) | 100% | 105% |
| higher is better | Shore A (23° C.) | 100% | 110% |
| | Shore A (1000° C.) | 100% | 103% |
| Modulus, | 100% Modulus (Die C, MPa) | 100% | 150% |
| Tensile, | 300% Modulus (Die C, MPa) | 100% | 126% |
| Elongation at | Tensile (Die C, MPa) | 100% | 125% |
| Break | Elongation at Break (%) | 100% | 102% |
| higher is better | | | |
| Abrasion | Grosch, High Severity (mg/km) | 100% | 87% |
| Resistance | DIN Relative Volume Loss | 100% | 93% |
| lower is better | | | |

It can be seen that a 20% silane-coupled CNTs in a high cis polybutadiene masterbatch results in superior dispersion of the nanotubes and coupling of the CNTs to the polymer matrix during curing. The working samples indicate that CNTs in the polybutadiene masterbatch is more reinforcing than a high silica loading in a conventional polymer blend. This allows for a substantial reduction in silica level.

It is also shown that such a masterbatch, used in a rubber composition, achieves a good balance of wet performance, treadwear, and rolling resistance. Additionally, the inventive sample demonstrates improved stiffness (indicated by the G′ modulus). Generally, the higher the value, the stiffer the cured composition is. It can be seen from Table 2 that stiffness (G′) increases in the cured experimental rubber compositions at the probed strain levels. A predictive, beneficially increased stiffness of a tread rubber composition is evidenced, for example, by an increased storage modulus (G′) property of the cured rubber composition at the probed strain levels. In tire tread rubber compositions, this increased stiffness property is often desired to promote better tire handling characteristics.

The Inventive Sample is a 2% lower specific gravity, which means that it is lighter weight. The inventive sample also demonstrates improved processing.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire comprising a rubber composition, the rubber composition based on 100 parts per weight (phr) elastomer, comprising:
a silane-coupled carbon nanotube (CNT) comprised in a polybutadiene masterbatch,
a first elastomer mixed with the masterbatch, the first elastomer being the same as or different from the polybutadiene in the masterbatch; and
optionally a second elastomer mixed with the masterbatch;
wherein a total elastomer in the rubber composition comprises:
from about 25 phr to about 75 phr of the polybutadiene; and
from about 25 to about 75 phr of at least the first or second elastomer.

2. The rubber composition of claim 1, wherein the masterbatch comprises between 5% by weight and 30% by weight of the CNT.

3. The rubber composition of claim 1, wherein one of the first and second elastomers is styrene butadiene rubber (SSBR).

4. The rubber composition of claim 1, at least one of the first and second elastomers is functionalized.

5. The rubber composition of claim 1, wherein one of the first and second elastomers is polybutadiene.

6. The rubber composition of claim 1, wherein the polybutadiene is the same as polybutadiene comprised in the masterbatch.

7. The rubber composition of claim 1, wherein the polybutadiene is different than the polybutadiene comprised in the masterbatch.

8. The rubber composition of claim 1, wherein the masterbatch comprises a silane.

9. The rubber composition of claim 1 further comprising a freely added mercapto silane.

10. The rubber composition of claim 9, wherein the freely added mercapto silane is a blocked mercaptosilane.

11. The tire of claim 1, wherein the rubber composition is incorporated in one of a tread, sidewall, a carcass cord ply coat, tire sidewall stiffening insert, an apex, a wire coat, inner liner tire chafer, and/or tire bead component.

12. A tire comprising a rubber composition, the rubber composition based on 100 parts per weight (phr) elastomer, comprising:
from about 1 phr to about 50 phr of a first polybutadiene comprised in a dry masterbatch in which surface-functionalized carbon nanotubes are dispersed;
a second polybutadiene blended with the masterbatch, the second polybutadiene being same or different from the first polybutadiene;
optionally at least one other diene rubber;
at least one reinforcement filler, comprising:
from about 1 to about 15 phr of the silane coupled nanotubes comprised in the masterbatch; and
at least one additional filler comprising at least one of silica and carbon black.

13. The rubber composition of claim 1, wherein a combined total of the first and second polybutadienes is less than or equal to 50 phr in the rubber composition.

14. The rubber composition of claim 1, wherein the first polybutadiene is characterized by a cis content greater than 90%.

15. The rubber composition of claim 1, wherein at least one of the second polybutadiene and the optional other diene is functionalized.

16. The tire of claim 12, wherein the rubber composition is incorporated in one of a tread, sidewall, a carcass cord ply coat, tire sidewall stiffening insert, an apex, a wire coat, inner liner tire chafer, and/or tire bead component.

17. A process for forming a rubber composition for use in a tire, the process comprising:
obtaining a masterbatch comprising greater than 10% by weight surface-functionalized carbon nanotubes (CNTs) dispersed in polybutadiene;
diluting the masterbatch to obtain a select level of carbon nanotubes in a final rubber composition, the diluting comprising:
incorporating additional diene into a rubber mixture comprising the masterbatch, the additional diene being the same or different from the first polybutadiene;
optionally incorporating filler into the rubber mixture;
wherein the final rubber composition comprises between 2 and 15 parts per weight (phr) of surface-functionalized carbon nanotubes based on 100 phr of elastomer.

18. The process of claim 17, wherein the masterbatch comprises between 15% by weight and 25% by weight of the CNT.

19. The tire of claim 17, wherein the rubber composition is incorporated in one of a tread, sidewall, a carcass cord ply coat, tire sidewall stiffening insert, an apex, a wire coat, inner liner tire chafer, and/or tire bead component.
